(19) United States
(12) Patent Application Publication
(10) Pub. No.: US 2007/0291306 A1
(43) Pub. Date: Dec. 20, 2007

(54) Image job totaling apparatus and image job totaling system

(75) Inventor: Akinobu Fujino, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/820,738

(22) Filed: Jun. 20, 2007

(30) Foreign Application Priority Data
Jun. 20, 2006 (JP) 2006-170620

(51) Int. Cl. G06F 3/12

(52) U.S. Cl. 358/1.15

(57) ABSTRACT

An image job totaling apparatus which acquires an operating state of an image processing apparatus detects occurrence of an error in the image processing apparatus at an early stage, while reducing the load of processing to acquire the operating state as much as possible. A job information notification section 212 of an image processing apparatus (A) 2 notifies image job processing information to an account server 1 each time print processing or copy processing is performed. A totalization processing section 111 performs totalization processing to the image job processing information sent from the image processing apparatus (A) 2. A status transmission section 211 of the image processing apparatus (A) 2 transmits an error state and the amount of consumables of the image processing apparatus (A) 2 in response to a request of a status acquisition management section 113 of the account server 1. A notification frequency management section 114 of the account server 1 calculates a notification frequency of the image job processing information sent from the image processing apparatus (A) 2, and the status acquisition management section 113 performs a status request to the image processing apparatus (A) 2 on the basis of the notification frequency.

### BACKGROUND OF THE INVENTION

1. Field of the Invention

The present invention relates to an image job totaling apparatus and an image job totaling system which monitor and total processing states of an image processing apparatus.

2. Description of the Related Art

In recent years, there exists an image processing apparatus management server which monitors processing states of an image processing apparatus having functions of a copy machine, a printer, a facsimile and the like. The management server receives processing results for respective jobs of copying, printing and the like from the image processing apparatus, and totals the processing results.

By making the management server perform such totalization processing, it is possible for an administrator of the image processing apparatus to know utilization states for every user of the image processing apparatus, the consumption of consumables such as paper sheets and a toner, and to take measures such as those of performing charging and placing the order of the consumables.

Further, the management server periodically acquires states relating to an error occurrence location, the amount of consumables or the like, as the current status of the image processing apparatus.

Meanwhile, there is a problem that an error of the image processing apparatus itself and a communication error between the management server and the image processing apparatus make it impossible for the management server to receive the processing results.

Japanese Patent Laid-Open No. 2002-149382 has disclosed that in order to reliably store job processing states during job execution, which may disappear due to a power supply interruption error, information on the progress during the job execution is stored in a nonvolatile memory, and after the error is recovered, the information stored in the nonvolatile memory is transferred to an execution history information storage section which stores information on processing results of completed processing jobs.

In Japanese Patent Laid-Open No. 2002-149382, the management server is capable of totaling the states of job processing during execution after the error is recovered, but during the error occurrence period, the management server performs no special processing while the server cannot receive any processing result.

Thus, for example, in the case where a part of the image processing apparatus normally operates and performs job processing but the processing result cannot be received due to occurrence of an error in the network or the like, there arises a problem that the management server which periodically performs totalization processing cannot obtain a correct totalization result, if the totalization timing is in the error occurrence period.

Further, when receiving no processing result, the management server judges that no job processing is performed in the image processing apparatus. As a result, the management server does not receive any processing result for a fixed period, and is unable to recognize the occurrence of an error on the side of the image processing apparatus and to issue a warning.

On the other hand, it is possible for the management server to detect the occurrence of the error by periodically acquiring the current status of the image processing apparatus, and to detect the occurrence of the error at an earlier stage by shortening the acquisition interval. However, in the image processing apparatus having a lower frequency of job processing, the number of times of error occurrence is small, and hence there is a problem that the load of status acquisition processing of the management server is only increased even by frequently acquiring the status of such image processing apparatus.

In view of the above described problem, it is an object of the present invention to provide an image job totaling apparatus and an image job totaling system which are capable of detecting occurrence of an error in an image processing apparatus in an early stage, while reducing the processing load for acquiring states of the image processing apparatus as much as possible.

A further object of the present invention is to provide an image job totaling apparatus and an image job totaling system which are capable of estimating, on the basis of a past notification frequency, whether or not an error occurs in the image processing apparatus at the time of totalization processing, and of issuing a warning to an administrator.

A further object of the present invention is to provide an image job totaling apparatus and an image job totaling system which are capable of estimating, on the basis of a past notification state, whether or not a processing result is a result received after the error is recovered in the image processing apparatus, and preferentially performing processing which cannot be performed during the error occurrence period.

### SUMMARY OF THE INVENTION

In order to achieve the above described objects, according to the present invention, there is provided an image job totaling apparatus characterized by including: a receiving section which is connectable to an image processing apparatus via a network and receives notification about image job processing information from the image processing apparatus at each time of image job processing; a notification frequency calculation section which calculates a notification frequency of processing information within a predetermined period on the basis of the received notification; and a state acquisition section which acquires a state of the image processing apparatus on the basis of the calculated notification frequency.

According to the above described constitution, the notification frequency of processing information within the predetermined period is calculated, and the state of the image processing apparatus is acquired on the basis of the calculated notification frequency, as a result of which it is possible to acquire a state such as occurrence of an error at an early stage.

Here, the image processing apparatus is a device having one or more image processing functions of a printer, a copy machine, a scanner, a facsimile and the like. The image job processing information means a result of image job processing performed by the image processing apparatus, and includes, for example, date and time of image job processing, contents of image job processing, the number of sheets processed in image job, or the like.

The state acquisition section acquires the state (status) of consumables, an error and the like of the image processing apparatus. The image job totaling apparatus performs totalization processing on the basis of the image job processing information sent from the image processing apparatus, and monitors the image processing apparatus by making the state acquisition section acquire the state (status) of consumables, an error or the like of the image processing apparatus.

Further, the state acquisition section is capable of changing the frequency of acquiring the state of the image processing apparatus on the basis of the notification frequency. According to the above described constitution, by calculating the notification frequency of the processing information sent from the image processing apparatus, it is possible to acquire the state of the image processing apparatus according to the notification frequency. As the notification frequency becomes high, the image job processing frequency is increased, and the number of times of failure and the replenishment frequency of consumables are increased. Thus, for the image processing apparatus having a high image job processing frequency, it is possible to detect occurrence of an error in the image processing apparatus at an early stage by increasing the state acquisition frequency. On the contrary, for the image processing apparatus having a low image job processing frequency, the monitoring load is reduced by reducing the state acquisition frequency.

When receiving two or more pieces of image job processing information, the state acquisition section is capable of acquiring the state of the image processing apparatus on the basis of the number of received image jobs and the image job notification frequency.

The image processing apparatus performs the notification at the time of each image job processing, and hence the processing information of one image job is received as one piece of notification. The image processing apparatus is capable of simultaneously performing a plurality of image processing functions, and hence the processing information on a plurality of image jobs which are simultaneously processed and continuously processed may be received from the image processing apparatus having a high image job processing frequency. In the case where the processing information on a plurality of image jobs is received at a time although the image job processing frequency is low, there is a possibility that the processing information could not be sent as a result of a certain abnormality caused in the image processing apparatus or the network.

Thus, in the case where a plurality of pieces of image job processing information are received although the image job processing frequency is low, it is possible to confirm an error state of the image processing apparatus or the network by estimating that the processing information could not be sent as a result of a certain abnormality caused in the image processing apparatus or the network, and by newly acquiring the state of the image processing apparatus.

Further, in the image processing apparatus having a high image job processing frequency, in the case where the number of pieces of received image job processing information is large even in consideration of the execution of the simultaneous processing and the continuous processing, it is possible to confirm an error state of the image processing apparatus or the network by estimating that the processing information could not be sent as a result of a certain abnormality caused in the image processing apparatus or the network, and by newly acquiring the state of the image processing apparatus.

Further, when the sum of the number of sheets of the received image job processing information is large, the consumables or the like of the image processing apparatus may be consumed. Thus, it is possible to preferentially perform processing to replenish consumables, or the like, which cannot be performed during the error occurrence period, by newly acquiring the state of the image processing apparatus.

Further, the image job totaling apparatus according to the present invention includes: a totalization processing section which totals image job processing information within a predetermined period; and a notification frequency judging section which judges, on the basis of a notification frequency before the predetermined period, whether or not a notification state of the processing information within the predetermined period is appropriate, wherein the totalization processing section totals the image job processing information within the predetermined period according to the result of the judgment performed by the notification frequency judging section. In the case of the judgment result that the notification state is not appropriate, the totalization processing section is enabled to change the totalization timing of the image job processing information within the predetermined period.

According to the above described constitution, in the case where the notification frequency within the predetermined period is low as compared with a conventional notification frequency before the predetermined period, it is possible to judge that the notification may not be performed as a result of occurrence of an error in the image processing apparatus or the network, and to perform totalization processing according to the judgment result. As the totalization processing according to the judgment result, it is possible to change the totalization timing until all the pieces of image job processing information within the predetermined period are available.

Further, the image job totaling apparatus according to the present invention includes: a communication section which is connectable to an administrator terminal via the network; and a warning processing section which issues a warning to the administrator terminal when it is judged by the notification frequency judging section that the notification state is not appropriate.

According to the above described constitution, in the case where the notification frequency within the predetermined period is low as compared with a conventional notification frequency before the predetermined period, it is judged that there is a possibility that the notification cannot be performed as a result of occurrence of an error in the image processing apparatus or the network, and a warning of the abnormality is issued to the administrator of the image processing apparatus. This makes it possible for the administrator to check the state of the image processing apparatus and the network, and to make the error recovery processing performed.

Further, the notification frequency judging section is capable of judging whether or not the notification state within the predetermined period is appropriate, according to whether or not a warning condition set by the user on the basis of the notification frequency before the predetermined period coincides with the notification state within the predetermined period. According to the above described constitution, it is possible for the user to freely set the warning condition.

Further, in the image job totaling system according to the present invention, the image job totaling apparatus is connected to the image processing apparatus via the network. The image processing apparatus includes a storage section which stores image job processing information at each time of image job execution, and a transmitting section which, when the image job processing information is stored, transmits a notification on the image job processing information. In the case where the notification on the image job processing information cannot be performed as a result of occurrence of an error in the own image processing apparatus or the network, it is possible for the transmitting section to collectively transmit the processing information on image jobs performed within the error occurrence period.

According to the above described constitution, in the case where the notification of image job processing information cannot be performed as a result of occurrence of an error, it is possible for the image processing apparatus to transmit the processing information on image jobs performed within the error occurrence period after the error is recovered. The image job totaling apparatus is capable of collectively receive the image job processing information which could not be received due to the occurrence of error, after the error is recovered. Thus, when collectively receiving a plurality of pieces of image job processing information, the image job totaling apparatus is capable of preferentially performing processing to replenish consumables, or the like, which could not be performed during the error occurrence period.

As described above, the notification frequency of the processing information sent from the image processing apparatus is calculated, so that it is possible to acquire the states from the image processing apparatus according to the notification frequency. As the notification frequency becomes high, the image job processing frequency is increased, so that the number of times of failure and the replenishment frequency of consumables are increased. Thus, for the image processing apparatus having a high image job processing frequency, it is possible to detect occurrence of an error in the image processing apparatus at an early stage by increasing the state acquisition frequency. Further, for the image processing apparatus having a low image job processing frequency, since the possibility of occurrence of an error is low, it is possible to reduce the monitoring load of the image job totaling apparatus by reducing the state acquisition frequency.

### BRIEF DESCRIPTION OF THE DRAWINGS

FIG. 1 is a block diagram of an image job totaling apparatus and an image job totaling system according to the present invention;

FIG. 2 is a flow chart of processing in an account server, to acquire states of the image processing apparatus on the basis of a notification frequency;

FIG. 3 is a figure showing an example of job history stored in the account server;

FIG. 4 is a figure showing examples of notification frequencies of job information and warning rules stored in the account server;

FIG. 5 is a flow chart of processing in the image processing apparatus, to notify the job information to the account server;

FIG. 6 is a flow chart of totalization processing in the account server;

FIG. 7 is a flow chart of processing to issue a warning to an administrator of an administrator PC;

FIG. 8 is an example of a screen in the administrator PC, in which failure notification is displayed;

FIG. 9 is an example of a screen in the administrator PC, in which notification of totalization processing is displayed;

FIG. 10 is a flow chart of processing upon receipt of job information in the account server;

FIG. 11 is a flow chart of processing to register job information in a storage section in the account server;

FIG. 12 is an example of a screen for setting a warning timing in the case where an unnotified state continues in the administrator PC;

FIG. 13 is a figure showing examples of consumable warning conditions stored in the account server; and

FIG. 14 is a flow chart of processing in the account server, to issue a warning of failure in the image processing apparatus on the basis of the notification frequency.

### DETAILED DESCRIPTION OF THE PREFERRED EMBODIMENTS

In the following, embodiments of an image job totaling apparatus and an image job totaling system according to the present invention will be described in more detail with reference to the accompanying drawings.

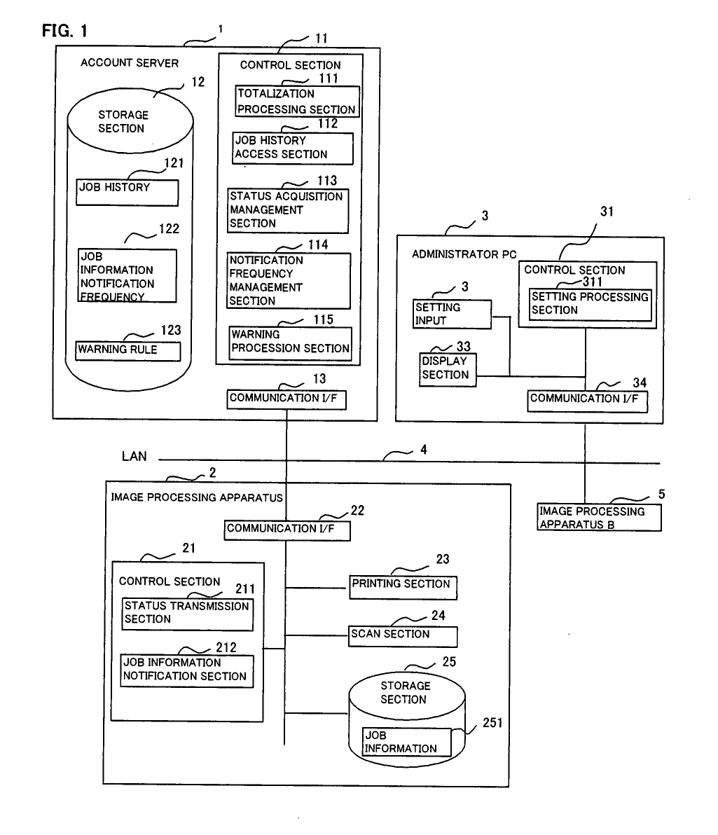

First, a fundamental constitution of the image job totaling apparatus and the image job totaling system is explained. FIG. 1 shows a block diagram of the image job totaling apparatus and the image job totaling system according to the present invention. In the image job totaling system shown in FIG. 1, an account server 1, an administrator PC 3, an image processing apparatus (A) 2, and an image processing apparatus (B) 5 are connected to each other via a network 4.

The account server 1 is an image job totaling apparatus according to the present invention, and mainly performs totalization processing of image job processing results on the basis of image job processing information sent from the image processing apparatus (A) 2 and the image processing apparatus (B) 5.

The account server 1 includes a control section 11, a storage section 12, and a communication I/F 13. The control section 11 is a CPU, and includes a totalization processing section 111, a job history access section 112, a status acquisition management section 113, a notification frequency management section 114, and a warning processing section 115.

The storage section 12 is an HDD or a memory, and stores a job history 121, a job information notification frequency 122, and a warning rule 123.

The totalization processing section 111 constitutes a totalization processing section which performs totalization processing on the basis of the image job processing information sent from the image processing apparatus (A) 2 and the image processing apparatus (B) 5. The job history access section 112, which accesses the job history 121 in the storage section 12, stores and preserves in the job history 121 the image job processing information sent from the image processing apparatus (A) 2 and the image processing apparatus (B) 5, and reads the image job processing information in the job history 121 for the totalization processing in the totalization processing section 111.

The status acquisition management section 113 acquires states of the image processing apparatus (A) 2 and the image processing apparatus (B) 5.

The notification frequency management section 114 calculates the notification frequency of the image job processing information sent from the image processing apparatus (A) 2 and the image processing apparatus (B) 5, and stores and manages the job information notification frequency 122 in the storage section 12. Further, the notification frequency management section 114 judges whether or not the notification state is appropriate, on the basis of the calculated notification frequency.

The warning processing section 115 constitutes a warning processing section which issues a warning of failure in the image processing apparatus (A) 2 or the image processing apparatus (B) 5 and notifies a totalization result to the administrator PC 3. The warning rule 123 in the storage section 12 is a condition on which a warning is issued to the administrator PC 3, and which can be set by a user of the administrator PC 3.

The communication I/F 13 constitutes a communication section which performs transmission/reception of information to/from the network 4.

Next, the image processing apparatus according to the present invention is explained. The image processing apparatus (A) 2 is constituted by a control section 21, a communication I/F 22 which performs transmission/reception of information to/from the network 4, a printing section 23, a scan section 24, and a storage section 25. The control section 21 is constituted by a status transmission section 211 and a job information notification section 212. The status transmission section 211 transmits states of the image processing apparatus (A) 2 in response to a request from the status acquisition management section 113 of the account server 1. The states of the image processing apparatus (A) include an error state, an operating state during print processing and the like, the amount of consumables such as paper sheets and a toner.

The job information notification section 212 notifies job information obtained by subjecting image data sent from a PC (not shown) to print processing in the printing section 23, job information obtained by scan processing in the scan section 24, job information obtained by document copy processing in the scan section 24 and the printing section 23, job information obtained by FAX processing by using a telephone line (not shown), or the like, to the account server 1 upon completion of the processing of the jobs.

In job information 251 in the storage section 25, the job information resulting from the print processing, the scan processing, the copy processing, or the FAX processing is temporarily stored. When the job information 251 cannot be transmitted to the account server 1 due to an error caused in the image processing apparatus (A) 2 or the network 4, the job information 251 is stored in the storage section 25 until the transmission of the information is completed.

Here, the job information 251 which is notified by the job information notification section 212 and different from the state of the image processing apparatus (A) acquired by the status acquisition management section 113, is transmitted. The job information 251 is information on the job whose processing is completed, while the state of the image processing apparatus (A) is not information on the job whose processing is completed, but means a current status on the operating state, the amount of consumables, and the like.

Next, the administrator PC 3 according to the present invention is explained. The administrator PC 3 is constituted by a control section 31, a setting input section 32, a display section 33 and a communication I/F 34 which performs transmission/reception of information to/from the network 4, and is utilized by the administrator of the image processing apparatus (A) 2 and the image processing apparatus (B) 5. A setting processing section 311 of the control section 31 performs processing for setting the warning rule 123 of the account server 1. The setting input section 32 is adapted to enable the administrator to perform, by using a keyboard and a mouse, a setting input of the warning rule 123 and a selection input in response to the notification from the warning processing section 115 of the account server 1. The display section 33 is a display and displays to the administrator the notification from the warning processing section 115 of the account server.

The image processing apparatus (B) 5 according to the present invention has the same constitution as that of the image processing apparatus (A), and hence the explanation thereof is omitted.

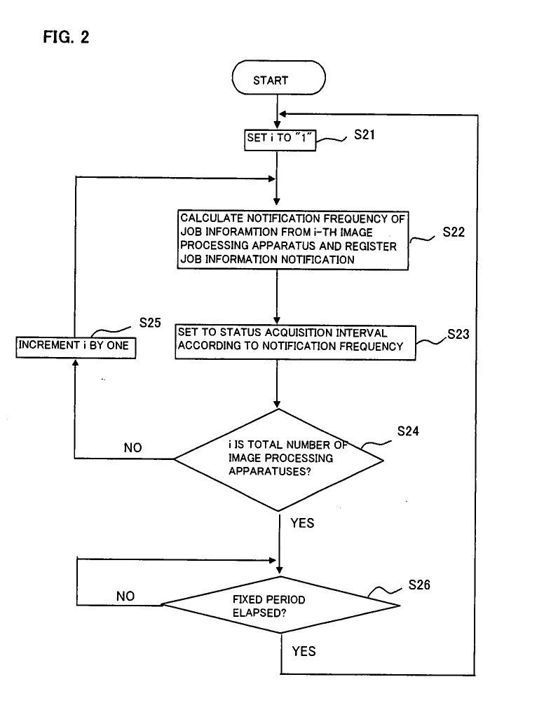

FIG. 2 shows a flow chart of processing in the account server 1, to acquire states of image processing apparatuses on the basis of the notification frequency. First, the control section 11 of the account server 1 sets i to “1” as initial setting (S21). Then, a job information notification frequency from an i-th image processing apparatus is calculated by the notification frequency management section 114, and the calculation result is registered in the storage section 12 as the job information notification frequency 122 (S22). That is, the notification frequency management section 114 constitutes a notification frequency calculation section which calculates the notification frequency of processing information within a predetermined period. The account server 1 performs totalization processing of job information sent from a plurality of image processing apparatuses such as the image processing apparatus (A) 2 and the image processing apparatus (B) 5. To this end, the account server 1 calculates the job information notification frequency for each image processing apparatus. After the registration of the job information notification frequency, the status acquisition management section 113 sets the status acquisition interval to a value corresponding to the notification frequency (S23). That is, the status acquisition management section 113 constitutes a state acquisition section which acquires the state of the image processing apparatus on the basis of the notification frequency.

For example, as the notification frequency is high, the image job processing frequency in the image processing apparatus becomes high, so that the number of times of failure and the replenishment frequency of consumables are increased. For this reason, the interval for acquiring the status including operating states such as an error state and the amount of consumables from the image processing apparatus is shortened.

Next, it is judged whether or not i is the number of all the image processing apparatuses to which the account server 1 performs the totalization processing (S24). When i is less than the number of all the image processing apparatuses, i is increased by one (S25) and the processing in S22 and S23 is performed to the next image processing apparatus. When i is the number of all the image processing apparatuses in S24, the processing in S22 and S23 has been performed for all the image processing apparatuses, and hence the process proceeds to S26. In S26, it is judged whether or not a fixed period has elapsed. When the fixed time has elapsed, the process proceeds to S21. For example, the fixed period is set to a period such as one week or one month. The processing in S22 and S23 is performed to all the image processing apparatuses for every fixed period, so that the status acquisition interval is set.

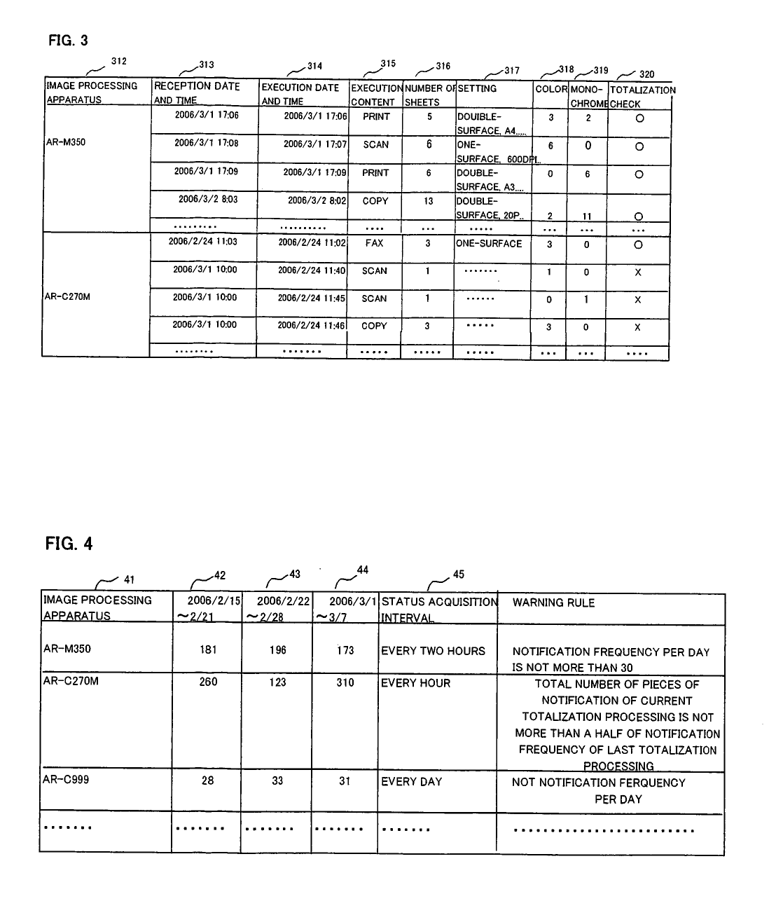

FIG. 3 shows an example of job history 121 stored in the account server 1. The job information of an image job notified from the image processing apparatus (A) 2 or the image processing apparatus (B) 5 includes an image processing apparatus 312, an execution date and time 314, an execution content 315, the number of sheets 316, settings 317, color 318, and monochrome 319. A reception date and time 313 is a date and time when the notification of the job information of the image job is received by the account server 1. Thus, the reception date and time 313 is not included in the notified job information but generated by the account server 1. The job history 121 stored in the storage section of the account server 1 is obtained by collecting the reception date and time 313, a totalization check 320, and the job information notified from the image processing apparatus (A) 2 or the image processing apparatus (B) 5.

In FIG. 3, the “image processing apparatus” 312 is information for identifying an image processing apparatus. For example, “AR-M350” indicates the image processing apparatus (A) 2, while “AR-C270M” indicates the image processing apparatus (B) 5. The “execution date and time” 314 is a date and time when the processing of an image job is executed and completed by the image processing apparatus (A) 2 or the image processing apparatus (B) 5. The “execution content” 315 means the processing content of an image job. When the processing content is the print processing, the “execution content” is stored as “print”. When the processing content is the scan processing, the “execution content” is stored as “scan”. When the processing content is the copy processing, the “execution content” is stored as “copy”. When the processing content is the Fax processing, the “execution content” is stored as “FAX”.

The “number of sheets” 316 means the number of sheets executed in the processing, and in the print processing and the copy processing, the number of printed paper sheets is stored. In the scan processing, the number of scanned document sheets is stored. In the FAX processing, the number of printed paper sheets according to FAX reception, or the number of scanned document sheets according to FAX transmission is stored. In the FAX processing, the information on the number of sheets 316 is different for FAX reception and FAX transmission, and hence information for identifying whether the information on the number of sheets 316 corresponds to FAX reception or FAX transmission may also be stored.

The “settings” 317 mean set contents of processing, and in the printer processing and the copy processing, the contents of print settings, such as “double-surface/one-surface printing”, “paper sheet size”, “staple printing” and “N-UP printing” are stored. In the scan processing, the contents of scan settings, such as “reading resolution”, “reading document size”, and “transmission destination” are stored. In the FAX processing, the contents of FAX settings, such as “telephone number of FAX destination for transmission/reception”, are stored.

The “color” 318 means the number of sheets subjected to color processing among the “number of sheets” 316, while “monochrome” 319 means the number of sheets subjected to monochrome processing among the “number of sheets” 316. The sum of the “color” 318 and the “monochrome” 319 is the “number of sheets” 316.

The “totalization check” 320 means check information as to whether the totalization processing is performed in the totalization processing section 111. When the totalization processing is performed, the symbol “◯” is stored, while when totalization processing is not performed after the notification from the image processing apparatus (A) 2 or the image processing apparatus (B) 5, the symbol “×” is stored.

FIG. 4 shows examples of the job information notification frequency 122 and the warning rule 123 which are stored in the account server 1. An image processing apparatus 41 is information for identifying an image processing apparatus. For example, “AR-M350” indicates the image processing apparatus (A) 2, while “AR-C270M” indicates the image processing apparatus (B) 5. A value in “2006/2/15-2/21” 42 indicates a notification frequency (the number of pieces of notification) of job information from the image processing apparatus 41 during a period from Feb. 15, 2006 to February 21, which notification frequency is calculated by the notification frequency management section 114 on the basis of the job history in FIG. 3. On the basis of the job history 121 in FIG. 3, the notification frequency management section 114 counts the number of pieces of job information during the period from Feb. 15, 2006 to February 21 for each image processing apparatus 312.

Although not described in the job information of the job history 121 in FIG. 3, 181 times is stored in FIG. 4 as the notification frequency of “AR-M350” which is the image processing apparatus (A) 2. Similarly, a value in “2006/2/22-2/28” 43 indicates a notification frequency of job information during a period from Feb. 22, 2006 to February 28 in the reception date and time 313. A value in “2006/3/1-3/7” 44 indicates a notification frequency of job information during a period from Mar. 1, 2006 to March 7 in the reception date and time 313. A status acquisition interval 45 indicates an interval at which the status acquisition management section 113 acquires the state of the image processing apparatus 41.

A warning rule 46 is a condition on which a warning about a failure of the image processing apparatus or the network 4 is issued to the administrator PC 3. It is possible for the user of the administrator PC 3 to set the warning rule 46.

Here, specific processing shown in FIG. 2 is explained with reference to FIG. 4. In S22 shown in FIG. 2, the job information notification frequency is calculated by the notification frequency management section 114, and the calculation result is stored in the job information notification frequency 122 such as “2006/2/15-2/21” 42. The calculation timing for the period “2006/2/15-2/21” 42 is so set that the calculation is performed at the end of February 21. Then, the status acquisition interval 45 is set in S23. In “AR-M350” which is the image processing apparatus (A) 2, the job information notification frequency during the week of “2006/2/15-2/21” 42, that is, from Feb. 15, 2006 to February 21 is 181 times, and hence the status acquisition interval 45 during the next week from February 22 to February 28 is set to two hours. Further, the notification frequency (the number of pieces of notification) during the next week of “2006/2/22-2/28” 43 is 196 times, which is almost the same as the notification frequency of the previous week, and hence the status acquisition interval 45 during the next week from March 1 to March 7 is also set to two hours.

On the other hand, in “AR-C270M” which is the image processing apparatus (B) 5, the job information notification frequency during the week of “2006/2/15-2/21” 42, that is, from Feb. 15, 2006 to February 21 is 260 times, which is more than 181 times in “AR-M350”. Thus, the status acquisition interval 45 during the next week from February 22 to February 28 is set to one hour which is shorter than that in “AR-M350.”

In “AR-C999” as the image processing apparatus 41, the job information notification frequency during the week of “2006/2/15-2/21” 42, that is, from Feb. 15, 2006 to February 21 is 28 times, which is less than 181 times in “AR-M350”. Thus, the status acquisition interval 45 during the next week from February 22 to February 28 is set to one day which is longer than that in “AR-M350.”

In the above described examples, the status acquisition interval 45 during the period from Feb. 22, 2006 to February 28 is set at the end of February 21 on the basis of the job information notification frequency during the period of “2006/2/15-2/21” 42, and the status acquisition interval 45 during the period from Mar. 1, 2006 to March 7 is set at the end of February 28 on the basis of the job information notification frequency during the period of “2006/2/22-2/28” 43. Thus, it is judged in S26 whether or not one week as the fixed period has elapsed.

As described above, when the status acquisition interval 45 is determined on the basis of the notification frequency during one week in “AR-C270M” which is the image processing apparatus (B) 5, the notification frequency during the week of “2006/2/15-2/21” 42 is 260 times, and the notification frequency during the week of “2006/2/22-2/28” 43 is 123 times. When the notification frequency is extremely different in this way, the status acquisition interval 45 is also extremely changed. Thus, the notification frequency tendency during the week of “2006/2/15-2/21” 42 and the week of “2006/2/22-2/28” 43 may also be judged, to thereby determine at the end of February 28 the status acquisition interval 45 during the week from March 1 to March 7.

According to the above described account server 1, it is possible to determine the status acquisition interval 45 according to the notification frequency from the image processing apparatus 41. As the notification frequency from the image processing apparatus 41 is high, the image job processing frequency is increased, so that the number of times of failure and the replenishment frequency of consumables are increased. Thus, for the image processing apparatus 41 having a high processing frequency of image job, it is possible to detect occurrence of an error in the image processing apparatus 41 at an early stage by increasing the state acquisition frequency.

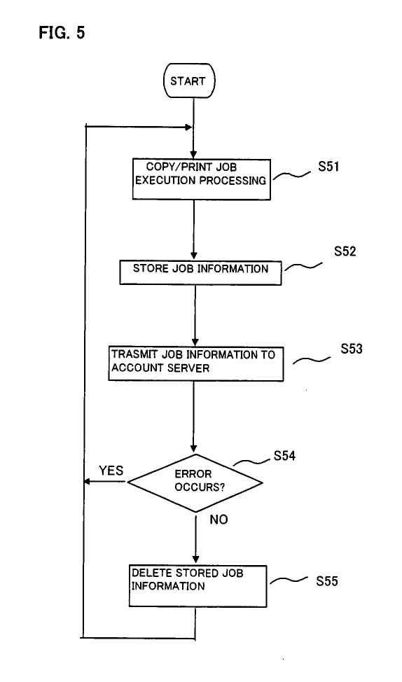

FIG. 5 shows a flow chart of processing to notify job information to the account server 1. First, according to the control of the control section 21, image jobs such as copy processing and print processing are performed in the printing section 23 and the scan section 24 (S51). Then, the job information of the image job executed and processed is stored as the job information 251 in the storage section 25 (S52). The job information includes the set contents set by the user before the job execution, such as “paper sheet size”, “double-surface/one-surface printing” and “reading resolution”, the number of processed sheets counted during the job execution, and the execution date and time. The stored job information 251 is notified to the account server 1 by the job information notification section 212 (S53). When the notification cannot be performed due to an error of the network 4 or the image processing apparatus (A) 2 (S54), the job information 251 is stored as it is in the storage section 25, and the processing of the next image job is performed (S51). After the processing of the next image job, the job information of the image job is further stored, and if the error is recovered, the stored job information 251 is notified. When the notification of the job information has been able to be performed in the state of no occurrence of an error in the network 4 or the image processing apparatus (A) 2 (S54), the job information 251 in the storage section 25 is deleted (S55), and the processing of the next image job is performed (S51). That is, during the period in which the notification cannot be performed due to the occurrence of the error, the job information 251 of image job is successively added and stored in the storage section 25, and all the stored job information 251 is collectively notified after the error is recovered.

In the image processing apparatus (A) 2, which is a composite machine having a plurality of functions of copy processing, print processing and the like, various errors may be caused. Therefore, even when an error occurs in a part of the functions, other functions may be normally operated. For example, even when an error occurs in the communication I/F 22 so that the print processing to receive and print the print data from a PC is not normally operated, the copy processing in which the communication I/F 22 is not used is normally operated. When the copy processing is normally operated but the job information 251 cannot be notified to the account server 1 due to the error in the communication I/F 22, the job information 251 is stored as it is in the storage section 25. Further, in the case where no error is caused in the image processing apparatus (A) 2, as a method for judging occurrence of a certain communication error in the network 4, it may be judged whether or not there is any response notifying receipt of the notification from the account server 1.

In the above described embodiment, occurrence of an error is judged in S54 after the processing is executed in S51, but the occurrence of an error in the image processing apparatus (A) 2 may also be judged during the execution of the processing in S51. According to the above described constitution, the image processing apparatus (A) 2, when being unable to perform notification about the image job processing information due to occurrence of an error, is capable of collectively transmitting all the processing information of image jobs performed during the error occurrence period after the error is recovered.

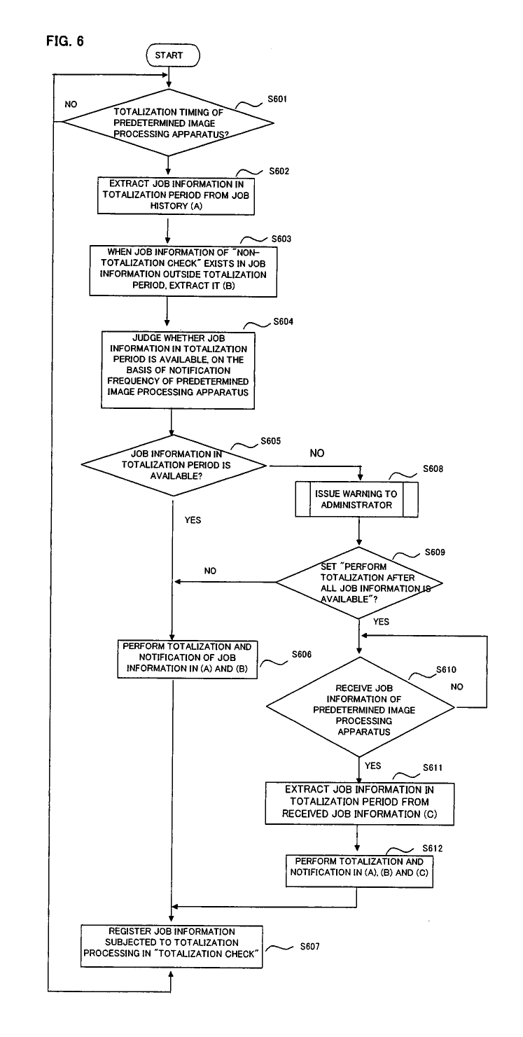

FIG. 6 shows a flow chart of totalization processing in the account server 1. First, it is judged whether or not there is any image processing apparatus reaching the totalization timing among the image processing apparatuses performing the notification to the account server 1 (S601). The totalization timing is determined beforehand for each image processing apparatus. The totalization processing is put on standby until an image processing apparatus reaches the totalization timing. When an image processing apparatus reaches the totalization timing, the process proceeds to S602. At the totalization timing of the image processing apparatus (A) 2, the job information having the execution date and time 314 within a totalization period is extracted from the job history 121 by using the job history access section 112 (S602). The totalization period is set beforehand to one week, one month or the like, for each image processing apparatus. The account server 1 performs processing of the order placement of consumables such as paper sheets and a toner, charging processing, maintenance and the like, on the basis of the totalization result of the job information. Therefore, since processing of the order placement of consumables, and the like, based on the totalization result is needed more for the image processing apparatus having a higher notification frequency, the totalization period of such image processing apparatus may be set to a short period. For example, in the case where the totalization processing is performed every day and Mar. 1, 2006 is in the totalization period, the job information on March 1 in the execution date and time 314 is extracted. After S602, when the job information indicated by “×” in the totalization check 320 exists among the job information outside the totalization period, the job history access section 112 extracts the job information (S603).

Here, the job information outside the totalization period and indicated by “×” in the totalization check 320 means information whose execution date and time 314 is before the totalization period, and which is not yet subjected to the totalization processing. For example, in “AR-C270M” in FIG. 3 which is subjected to the totalization processing every week, for the totalization period from Mar. 1, 2006 to March 7, the job information at “2006/2/24 11:40”, “2006/2/24 11:45” and “2006/2/24 11:46” of the execution date and time 314 is indicated by “×” and hence extracted. Usually, the job information is notified to the account server 1 immediately after the image job processing is executed, and hence the execution date and time 314 is not significantly different from the reception date and time 313.

However, as shown in FIG. 5, during the period in which the notification cannot be performed due to occurrence of an error in the image processing apparatus (A) 2 or the network 4, the job information of the image job processed during the error occurrence period is successively stored in the storage section 25, and the job information 251 in the storage section 25 is notified after the error is recovered. Therefore, the execution date and time 314 at which the image job processing is executed in the image processing apparatus (A) 2 may be significantly different from the reception date and time 314 at which the job information is received by the account server 1. The job information at “2006/2/24 11:40”, “2006/2/24 11:45” and “2006/2/24 11:46” of the execution date and time 314 could not be notified due to occurrence of an error in the image processing apparatus (A) 2 or the network 4, and hence is collectively notified at “2006/3/1 10:00” of the reception date and time 313 after the error is recovered. Without the occurrence of the error, the job information at “2006/2/24 11:40”, “2006/2/24 11:45” and “2006/2/24 11:46” was to be subjected to the totalization processing at the end of February 28 as the totalization timing during the totalization period from Feb. 22, 2006 to February 28. However, in this totalization timing, the job information was not received by the account server 1, and hence could not be subjected to the totalization processing.

Thus, the job information is extracted for the totalization processing in S603. After S603, the notification frequency management section 114 judges whether or not all the job information during the totalization period is available, on the basis of the notification frequency (S604). That is, the notification frequency management section 114 also includes a notification frequency judging section which judges whether or not a notification state is appropriate on the basis of a calculated notification frequency, in addition to the above described notification frequency calculation section.

For example, in the case where the image processing apparatus 41 in FIG. 4 is “AR-C270M” and the totalization processing for the period from Mar. 1, 2006 to March 7 is performed at the end of March 7, the notification frequency during the period of “2006/3/1-3/7” 44 is 310 times which is high as compared with 260 times during the period of “2006/2/15-2/21” 42 and 123 times during the period of “2006/2/22-2/28” 43. The notification frequency during the totalization period from March 1 to March 7 is higher than the notification frequency during the conventional totalization period, and hence it is judged that all the job information during the totalization period is available.

On the other hand, in the case where the image processing apparatus 41 is “AR-C270M” and the totalization processing for the period from Feb. 22, 2006 to February 28 is performed at the end of February 28, the notification frequency during the period of “2006/2/22-2/28” 43 is 123 times which is extremely low as compared with 260 times during the period of “2006/2/15-2/21” 42.

Thus, it is judged that the notification could not be performed possibly due to occurrence of an error during the period from Feb. 22, 2006 to February 28 and hence all the job information within the totalization period is not available. When all the job information within the totalization period is not available on the basis of the judgment in S604 (S605), a warning is issued to the administrator of the administrator PC 3 (S608).

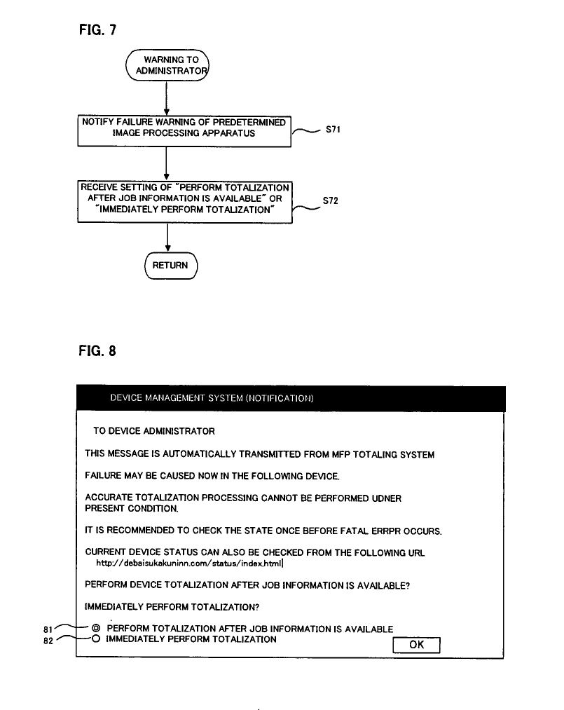

Here, FIG. 7 shows a flow chart of processing to issue the warning to the administrator of the administrator PC 3. FIG. 7 shows the detailed processing in S608. First, the warning processing section 115 notifies a failure of the image processing apparatus (A) 2 to the administrator PC 3 (S71). The administrator PC 3 which has received the notification displays the contents of the notification on the display section 33.

FIG. 8 shows an example of a screen, on the display section of which the failure notification is displayed, on the administrator PC 3 which has received the failure notification from the account server 1. The “device” in the screen shown in FIG. 8 indicates the “image processing apparatus”, and notifies that a failure may be caused in the image processing apparatus (A) 2. Further, the message of “the present status of the device can also be checked by the following URL” in the screen is for acquiring the states of the image processing apparatus (A) 2, and makes it possible to acquire the states of the image processing apparatus (A) 2 by using the status acquisition management section 113 of the account server 1 or directly from the administrator PC 3. The administrator performs a setting input of “perform totalization after all job information is available” 81, or “immediately perform totalization” 82 in relation to the totalization method of job information by using the setting input section 32. On the basis of the setting input, the setting processing is performed by the setting processing section 311, and the account server 1 receives the result of the setting processing on the notification method (S72).

After S72, the process proceeds to S609 in FIG. 6. In S609, it is judged whether or not the setting input of “perform totalization after all job information is available” 81 is set, and when the setting input is set, the process is put on standby until the job information from the image processing apparatus (A) 2 is received (S610). When the totalization timing of the other image processing apparatus is reached during the standby period in S610, the processing in S602 and succeeding steps is performed to the other image processing apparatus. When the job information is received from the image processing apparatus (A) 2, the job information having the execution date and time 314 within the totalization period is extracted from the received job information (S611). Thereafter, the totalization processing of the job information extracted in S602, S603 and S611 is performed in the totalization processing section 111, so that the totalization result is notified to the administrator PC 3 (S612).

FIG. 9 shows an example of a screen on the administrator PC 3, on the display section of which the notification of totalization processing is displayed. On the screen, it is shown that the administrator is urged to check the attached totalization result. Further, “in the present totalization processing, calculation is performed by including a period omitted in the last totalization processing” in the screen means that the totalization processing is performed by including the job information extracted in S603. For example, the present totalization processing is performed for the period of Mar. 1, 2006 to March 7 in “AR-C270M” in FIG. 3. However, the job information with the execution date and time 314 of “2006/2/24 11:40” and later was not subjected to the totalization processing in the last totalization processing, and hence is subjected to the present totalization processing.

In FIG. 6, when it is judged that all the job information within the totalization period is available (S605), or when the administrator sets the setting input of “immediately perform totalization” (S609), the totalization processing of the job information extracted in S602 and S603 is performed, and the totalization result is notified to the administrator PC 3 (S606).

Here, when the administrator sets the setting input of “immediately perform totalization” (S609) and the processing in S606 is performed, the job information which cannot be subjected to the current totalization processing is extracted in S603 at the time of the next totalization processing. After the notification processing in S606 and S612, the symbol “◯” is registered in the “totalization check” 320 of the job information subjected to the totalization processing (S607). Then, in S601, the process is put on standby until the totalization timing of the predetermined image processing apparatus is reached.

According to the above described constitution, when the notification frequency during the totalization period of the image processing apparatus (A) 2 is low as compared with the notification frequency during the conventional totalization period before the totalization period, it is possible to judge that the notification processing may not be performed due to occurrence of an error in the image processing apparatus (A) 2 or the network, and to perform the totalization processing according to the judgment result.

As the totalization processing according to the judgment result, the totalization processing can be put on standby until all the image job processing information within the totalization period is available. Further, even when the totalization processing is performed without being put on standby until all the image job processing information within the totalization period is available, the processing information which cannot be received during the error occurrence period can be subjected to the totalization processing together at the time of the next totalization processing.

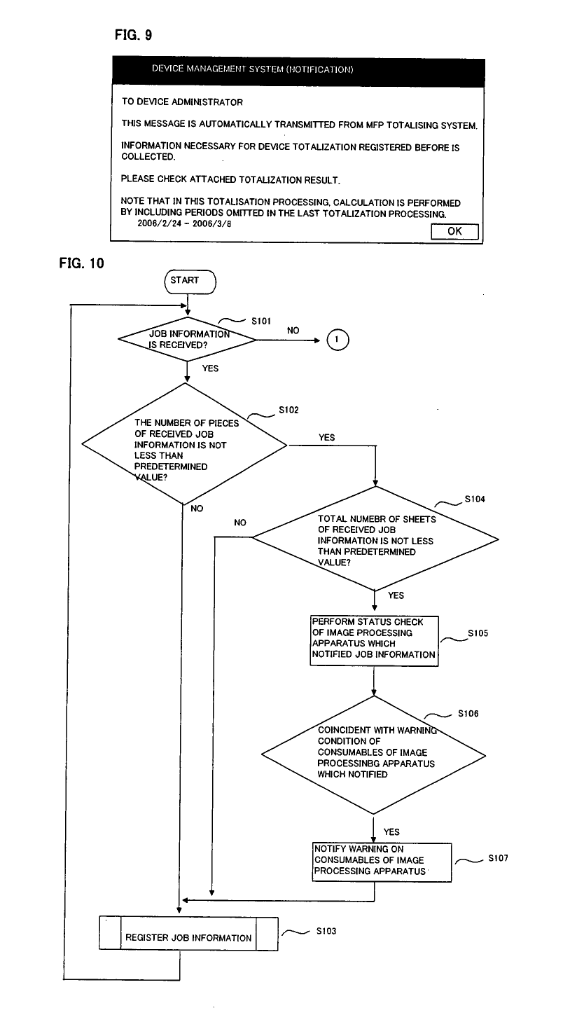

FIG. 10 shows a flow chart of processing upon receipt of the job information in the account server 1. First, when the job information is received from the image processing apparatus (A) 2 (S101), it is judged whether or not the number of pieces of the received job information is a predetermined value or more (S102). As shown in FIG. 5, after the error is recovered, the job information 251 of the image job processed during the error occurrence period is collectively notified. Thus, when the number of pieces of the received job information is large, the job information may be notified after the error is recovered.

On the other hand, in the image processing apparatus which frequently performs the image job processing, simultaneous processing of the copy processing, the print processing and the like may be performed to cause the job information of the plurality of image jobs to be notified at a time. In such a case, the job information is less likely to be notified after the error is recovered. Thus, the predetermined value in S102 may be determined according to the notification frequency of the image processing apparatus (A) 2. For example, from the image processing apparatus having a low notification frequency, the job information of a plurality of image jobs is less likely to be received at a time during normal operation, and hence the predetermined value is set to a low numerical value. From the image processing apparatus having a high notification frequency, the job information of two or three image jobs performed by the parallel processing may be received at a time, and hence the predetermined value is set to a high numerical value.

In S102, when the number of pieces of received job information is less than the predetermined value, the processing to register the job information in the storage section 12 is performed (S103).

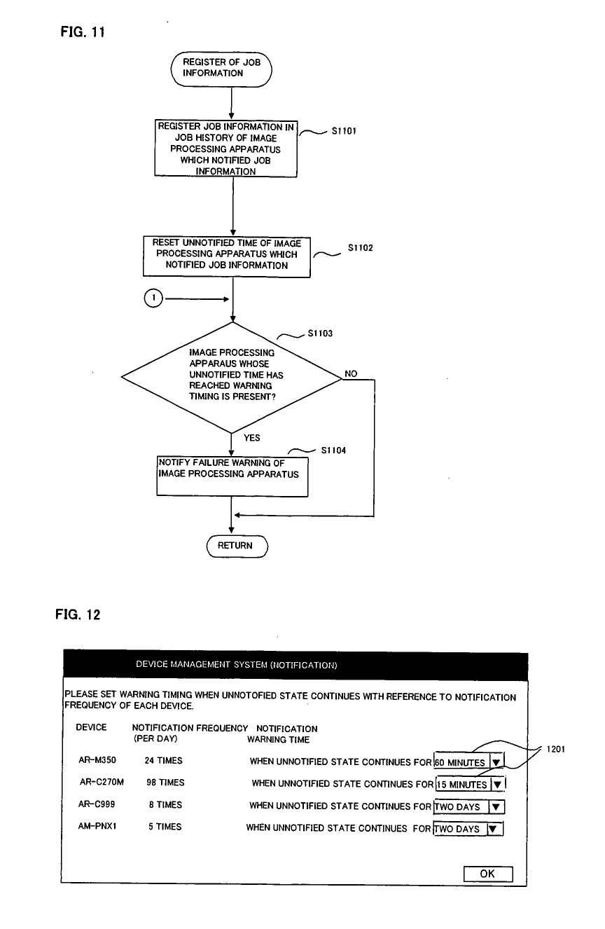

FIG. 11 shows a flow chart of the processing to register the job information in the storage section 12 in the account server 1. FIG. 11 shows detailed processing in S103. First, the job information is registered in the job history 121 of the image processing apparatus which notified the job information (S1101). The job history 121 is stored for each image processing apparatus 312, as shown in FIG. 3. When the image processing apparatus which notified the job information is “AR-M350”, the job information is registered as the job information of “AR-M350”. Next, an unnotified time of the image processing apparatus which notified the job information is reset (S1102). The unnotified time means the time period after the last notification is received, and is managed for each image processing apparatus. The unnotified time is measured in order to issue a warning to the administrator PC 3, when the unnotified state is continued.

Here, FIG. 12 shows an example of a screen in the administrator PC 3, on which the warning timing is set when the unnotified state continues. On the screen in FIG. 12, the notification frequency per day is displayed for each image processing apparatus, and the administrator performs a selection input 1201 of the nonnotification warning timing.

The selection input 1201 of the nonnotification warning timing performed by the administrator is stored in the account server 1 as the nonnotification warning timing for each image processing.

When there is an image processing apparatus with the unnotified time reaching the selection input 1201 of the nonnotification warning timing in the account server 1 (S1103), the warning on a failure of the image processing apparatus is notified to the administrator PC 3 (S1104). The judging processing in S1103 is always performed even during the period in which the job information is not received (S101).

Next, a case where the number of pieces of received job information is not less than the predetermined value in S102 is explained. When the number of pieces of job information received from the image processing apparatus (A) 2 is not less than the predetermined value, the job information on the image processing apparatus (A) 2 is more likely to be sent after the error is recovered. When the job information is sent after the error is recovered, it is necessary for the account server 1 to perform the processing which could not be performed during the error occurrence period. Thus, it is judged whether or not the sum of the number of sheets 316 of the received job information is not less than a fixed amount (S104). When the sum is not less than the fixed amount, the state of the image processing apparatus (A) 2 whose job information is notified is acquired by the status acquisition management section 113 (S105). When the number of sheets processed during the error occurrence period is large, the state after the error recovery is acquired, and the amount of consumables is checked. When the consumables are a toner and paper sheets, the number of sheets 316 of the scan processing does not influence the consumption, and hence the judgment in S104 may be performed on the basis of the sum of the number of sheets 316 of the copy processing and the print processing. Next, it is judged whether or not the state of the image processing apparatus (A) 2 acquired in S105 is coincident with a consumable warning condition (S106).

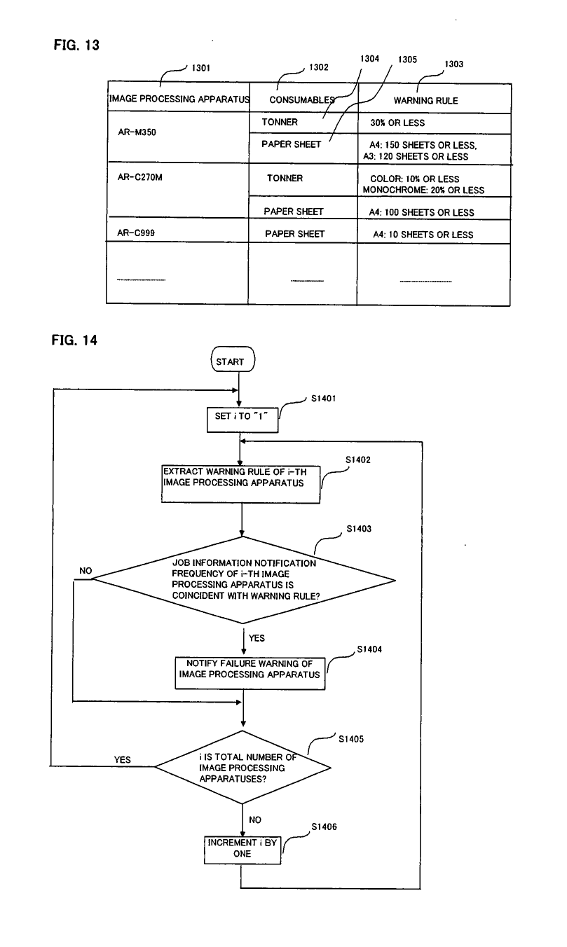

Here, the consumable warning condition is explained. FIG. 13 shows examples of the consumable warning condition stored in the storage section 12 of the account server 1. The consumable warning condition is stored as the warning rule 123 in the storage section 12. The consumable warning condition is constituted by an image processing apparatus 1301, a consumable 1302, and a warning rule 1303.

The image processing apparatus 1301 is a piece of information for identifying the image processing apparatus. The consumable 1302 is a kind of consumable provided for each image processing apparatus 1301, and includes a toner, paper sheets and the like. The warning rule 1303 means the amount of consumable on the basis of which a warning is issued to the administrator PC 3. The consumable warning condition is the warning rule 1303 of the consumable 1302 shown in FIG. 13.

In S106, it is judged whether or not the amount of consumable 1302 of the image processing apparatus (A) 2 is coincident with the warning rule 1303. When the amount of consumable 1302 is coincident with the warning rule 1303, a warning is issued to notify the administrator PC 3 that the amount of consumable is reduced. Then, the process proceeds to S103.

Further, when the sum of the number of sheets 316 of the job information received in S104 is less than the fixed amount, or when the state of the image processing apparatus (A) 2 is not coincident with the consumable warning condition in S106, the warning for notification is not issued and the processing in S103 is performed.

According to the above described constitution, when a plurality of pieces of image job processing information are received in spite of a low processing frequency of image job, it is possible to estimate that a certain abnormality may have occurred in the image processing apparatus (A) 2 or the network 4 and hampered transmission, and to confirm the error state of the image processing apparatus (A) 2 or the network 4 by acquiring the state of the image processing apparatus (A) 2.

Further, in the case where the number of pieces of the image job processing information received from the image processing apparatus (A) 2 having a high image job processing frequency is large even in consideration of the execution of simultaneous processing, it is possible to estimate that the image job processing information could not be sent due to a certain abnormality caused in the image processing apparatus (A) 2 or the network 4, and to confirm the error state of the image processing apparatus (A) 2 or the network 4, by acquiring the state of the image processing apparatus (A) 2. Further, after the error is already recovered, it is possible to preferentially perform the warning processing to replenish the consumables, which could not be performed during the error occurrence period, according to the states of consumables or the like of the image processing apparatus (A) 2.

FIG. 14 shows a flow chart of processing in the account server 1, to issue a warning of a failure in the image processing apparatus on the basis of the notification frequency. First, the control section 11 of the account server 1 sets i to “1” as initial setting (S1401). Then, the control section 11 extracts the warning rule 123 sent from the i-th image processing apparatus from the storage section 12 (S1402). For example, in the case where the image processing apparatus is “AR-C270M” in FIG. 4, the warning rule 46 is so set that “the total number of pieces of notification in the current totalization processing is not more than a half of the total number of pieces of notification in the last totalization processing”.

For example, in the warning rule 46, the total number of pieces of notification is 123 times during the period of “2006/2/22-2/28” 43 in comparison with 260 times during the period of “2006/2/15-2/21” 42. When the current totalization period is the period from February 22 to February 28, the total number of pieces of notification is not more than a half of the total number of pieces of notification during the last totalization period.

In S1403, it is judged whether or not the notification frequency of the i-th image processing apparatus is coincident with the warning rule. When the image processing apparatus is “AR-C270M” and the totalization period is the period from February 22 to February 28 in FIG. 4, the notification frequency is coincident with the warning rule 46 as described above. In the case of coincidence with the warning rule 46, the warning is issued to the administrator PC 3 to notify that a failure is caused in the i-th image processing apparatus (S1404). Thereafter, when i is not equal to the number of all the image processing apparatuses (S1406), i is incremented by one (S1407) and the processing from S1402 to S1404 is performed. When i is equal to the number of all the image processing apparatuses (S1406), since the processing from S1402 to S1404 has been performed for all the image processing apparatuses, the process returns to S1401, and the same processing is performed from the first image processing apparatus. In S1403, when the notification frequency is not coincident with the warning rule 46, the processing in S1405 is performed.

Note that the warning rule 46 may be set by the administrator of the administrator PC 3, or may be automatically set by the account server 1 on the basis of the notification frequency.

According to the above described constitution, when the notification frequency is coincident with the warning rule 46, it is judged that the image job processing information could not be notified due to an abnormality caused in the image processing apparatus or the network 4, and a warning of the abnormality is issued to the administrator of the image processing apparatus. Thereby, it is possible for the administrator to confirm the state of the image processing apparatus or the network, and to make the error recovery processing performed.

Note that the range of history collection of past information is not limited to one week, but one day unit, one month unit or one year unit may also be selected. Further, it is considered that the notification frequency from the image processing apparatus greatly varied depending upon the period, the system may also be constituted so as not to refer only to the last record, but to take into consideration the process retroactively to the past several records.

What is claimed is:

1. An image job totaling apparatus connectable to an image processing apparatus via a network, comprising:
a receiving section adapted to receive notification about image job processing information from the image processing apparatus at each time of image job processing;
a notification frequency calculation section adapted to calculate a notification frequency of the processing information within a predetermined period; and
a state acquisition section adapted to acquire a state of the image processing apparatus on the basis of the calculated notification frequency.

2. The image job totaling apparatus according to claim 1, wherein the state acquisition section changes a frequency for acquiring the state of the image processing apparatus on the basis of the calculated notification frequency.

3. The image job totaling apparatus according to claim 1, wherein when receiving two or more pieces of the image job processing information, the state acquisition section acquires the state of the image processing apparatus on the basis of the number of received image jobs and the notification frequency.

4. The image job totaling apparatus according to claim 1, further comprising:
a totalization processing section adapted to perform totalization processing of the image job processing information within the predetermined period; and
a notification frequency judging section adapted to judge whether or not the notification state of processing information within the predetermined period is appropriate, on the basis of the notification frequency before the predetermined period,
wherein the totalization processing section performs totalization processing of the image job processing information within the predetermined period according to the result of the judgment performed by the notification frequency judging section.

5. The image job totaling apparatus according to claim 4, wherein the totalization processing section changes a totalization timing of image job processing information within the predetermined period according to the judgment result that the notification state is not appropriate.

6. The image job totaling apparatus according to claim 4, further comprising:
a communication section connectable to an administrator terminal via the network; and
a warning processing section adapted, when the notification frequency judging section judges that the notification state is not appropriate, to issue a warning to the administrator terminal via the network.

7. The image job totaling apparatus according to claim 6, wherein the notification frequency judging section judges whether or not the notification state within the predetermined period is appropriate, by comparing warning conditions set by a user on the basis of the notification frequency before the predetermined period with the notification state within the predetermined period.

8. An image job totaling system in which an image job totaling apparatus and an image processing apparatus are connected to each other via a network,
wherein the image processing apparatus comprises a storage section adapted, each time an image job is executed, to store image job processing information, and
a transmitting section adapted, when the image job processing information is stored, to transmit notification about the image job processing information, and adapted, when being unable to perform the notification about the image job processing information due to occurrence of an error in the own apparatus or the network, to collectively transmit the image job processing information performed during the error occurrence period after the error is recovered, and
wherein the image job totaling apparatus comprises a receiving section adapted to receive the notification about the image job processing information from the image processing apparatus each time the image job processing is performed, a notification frequency calculation section adapted to calculate a notification frequency of the processing information within a predetermined period, and a state acquisition section adapted to acquire a state of the image processing apparatus on the basis of the calculated notification frequency.
